(19) United States
(12) Patent Application Publication
(10) Pub. No.: US 2022/0150708 A1
(43) Pub. Date: May 12, 2022

(54) METHODS AND APPARATUS FOR CONTROLLING AN AUTONOMOUS VEHICLE USING A REMOTE CONTROL DEVICE

(71) Applicant: Nuro, Inc., Mountain View, CA (US)

(72) Inventors: Paul Michael WHITE, Mountain View, CA (US); Tobias Boelter, Sunnyvale, CA (US)

(73) Assignee: Nuro, Inc., Mountain View, CA (US)

(21) Appl. No.: 17/520,252

(22) Filed: Nov. 5, 2021

Related U.S. Application Data
(60) Provisional application No. 63/112,374, filed on Nov. 11, 2020.

(51) Int. Cl. H04W 12/50; H04W 76/14; H04W 12/08; H04W 12/63; H04W 12/0471; G05D 1/00

(52) U.S. Cl. CPC H04W 12/50; H04W 76/14; H04W 12/08; G06F 21/31; H04W 12/0471; G05D 1/0022; H04W 12/63

(57) ABSTRACT

According to one aspect, a method comprising includes identifying a remote control as attempting to pair with a first vehicle, and determining whether the remote control is authorized to pair with the first vehicle, wherein determining whether the remote control is authorized to pair with the first vehicle includes determining whether credentials associated with the remote control indicate that the remote control is authorized to pair with the first vehicle. The method also includes causing the remote control to pair with the first vehicle when it is determined that the remote control is authorized to pair with the first vehicle, wherein causing the remote control to pair with the first vehicle enables the remote control to remotely control the first vehicle.

### CROSS-REFERENCE TO RELATED APPLICATION

This application claims priority to U.S. Provisional Application No. 63/112,374, filed Nov. 11, 2020, entitled “METHODS AND APPARATUS FOR CONTROLLING AN AUTONOMOUS VEHICLE USING A REMOTE CONTROL DEVICE,” which is incorporated herein by reference in its entirety.

### TECHNICAL FIELD

The disclosure relates to providing mechanisms which facilitate the operation of autonomous vehicles. More particularly, the disclosure relates to pairing a remote control device with a vehicle, and allowing the remote control device to control the vehicle.

### BACKGROUND

As the use of autonomous or self-driving vehicles increases, the ability to efficiently control such vehicles is also increasing. Autonomous or semi-autonomous vehicles may be remotely controlled through the use of teleoperation systems, or through the use of remote controls or controllers. In general, a remote control may be used to control a vehicle that is within a line-of-sight of the remote control. The ability to control a vehicle using a remote control allows vehicles to be readily controlled by a remote operator who is in the vicinity of the vehicle, and may effectively reduce the need for teleoperations systems. For example, when an autonomous or semi-autonomous vehicle is to be moved a relatively short distance, the ability to operate the vehicle to move with a remote control may generally be more efficient than utilizing an autonomy system or a teleoperations system to operate the vehicle.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a diagrammatic representation of an overall system which allows a remote control to be paired with a vehicle through a pairing system, and allows the paired remote control to control the vehicle substantially directly in accordance with an embodiment.

FIG. 5 is a block diagram representation of a pairing system, e.g., pairing system 452 of FIG. 4, in accordance with an embodiment.

FIG. 6 is a block diagram representation of an autonomous vehicle which includes a brain stem controller (BSC) that includes a remote control receiver arrangement, e.g., remote control receiver 342 of FIG. 3, in accordance with an embodiment.

FIGS. 7A and 7B are a process flow diagram which illustrates a first method of pairing a remote control with a selected vehicle in accordance with an embodiment.

FIG. 7C is a process flow diagram which illustrates a second method of pairing a remote control with a selected vehicle in accordance with an embodiment.

FIG. 8 is a process flow diagram which illustrates a method of utilizing a remote control in accordance with an embodiment.

FIG. 9 is a process flow diagram which illustrates a method of pairing a remote control to a selected vehicle, e.g., step 733 of FIG. 7B, in accordance with an embodiment.

FIG. 10 is a diagrammatic representation of an overall system which allows a remote control to be paired with a vehicle through a pairing system that utilizes certificates, and allows the paired remote control to control the vehicle substantially directly in accordance with an embodiment.

FIG. 11 is a process flow diagram which illustrates a method of pairing a remote control with a selected vehicle which involves the use of certificate sets in accordance with an embodiment.

FIG. 12 is a diagrammatic representation of an overall system which allows a remote control to be paired with a vehicle in accordance with an embodiment.

FIG. 13 is a process flow diagram which illustrates a method of enabling an authenticated user to use an authenticated remote control to control a vehicle in accordance with an embodiment.

FIG. 14 is a block diagram representation of a system which enables a determination to be made as to whether a user is authorized to remotely control a vehicle, in accordance with an embodiment.

FIG. 15 is a diagrammatic representation of a system which enables a remote control to be paired with a vehicle using radio communications in accordance with an embodiment.

### DESCRIPTION OF EXAMPLE EMBODIMENTS

### General Overview

According to one aspect, a method comprising includes identifying a remote control as attempting to pair with a first vehicle, and determining whether the remote control is authorized to pair with the first vehicle, wherein determining whether the remote control is authorized to pair with the first vehicle includes determining whether credentials associated with the remote control indicate that the remote control is authorized to pair with the first vehicle. The method also includes causing the remote control to pair with the first vehicle when it is determined that the remote control is authorized to pair with the first vehicle, wherein causing the remote control to pair with the first vehicle enables the remote control to remotely control the first vehicle. In one embodiment, determining whether the credentials associated with the remote control indicate that the remote control is authorized to pair with the first vehicle includes determining whether the credentials are current, wherein when the credentials are current, it is determined that the remote control is authorized to pair with the first vehicle.

In accordance with another aspect, logic is encoded in one or more tangible non-transitory, computer-readable media for execution. When executed, the logic is operable to identify a remote control as attempting to pair with a first vehicle, and to determine whether the remote control is authorized to pair with the first vehicle. The logic operable to determine whether the remote control is authorized to pair with the first vehicle is operable to determine whether credentials associated with the remote control indicate that the remote control is authorized to pair with the first vehicle. Finally, the logic is operable to cause the remote control to pair with the first vehicle when it is determined that the remote control is authorized to pair with the first vehicle, wherein the logic operable to cause the remote control to pair with the first vehicle enables the remote control to remotely control the first vehicle.

In accordance with yet another aspect, a pairing system includes a communications interface, a processing arrangement, and logic arranged to be executed by the processing arrangement. The communications interface is configured to enable communications on a network with a remote control and with a first device such as a first vehicle. The logic is operable to determine when the remote control is authorized to pair with the first device by determining whether credentials associated with the remote control indicate that the remote control is authorized to pair with the first device, and when it is determined that the remote control is authorized to pair with the first device, causing the remote control to pair with the first device such that the remote control controls operation of the first device.

A remote control may be paired to a vehicle using a pairing system which is in communication with both the remote control and the vehicle over one or more wireless networks. The pairing system pairs the remote control to the vehicle, and once a pairing is complete, the remote control may substantially directly remotely operate the vehicle. Prior to pairing the remote control with the vehicle, the pairing system may verify that a user in possession of the remote control has authorization to operate the vehicle. After the vehicle has completed operations while being controlled by the remote control, the remote control may be automatically unpaired from the vehicle. As such, remote controls may be readily reused to control different vehicles, and issues relating to an unauthorized individual using a remote control to control a vehicle, as well as issues relating to being unable to identify which vehicle is paired with a particular remote control, may be substantially mitigated.

In one embodiment, a user or operator may be authorized to use a remote control device to control one or more vehicles. The remote control device may then be paired to a vehicle that the user or operator is authorized to control. The pairing between the remote control device and the vehicle may be accomplished using a radio communications channel such as a near field communications (NFC) communication channel. Thus, a user may be substantially authenticated or authorized to use a remote control device to control a particular vehicle, and the remote control device may be paired to the particular vehicle such that the user is effectively paired with the particular vehicle.

### DESCRIPTION

Remote controls may be used to operate or to otherwise control vehicles, e.g., autonomous or semi-autonomous vehicles, which are in the vicinity of the remote controls. For example, a remote control device may be used to control the movement or other behavior of a vehicle which is effectively within a line-of-sight of the vehicle. An overall framework for controlling autonomous vehicles which use remote controls or controllers may be implemented relatively efficiently, as the infrastructure associated with remote controls is generally less complicated than infrastructures associated with teleoperation systems.

Autonomous vehicle fleets may include multiple autonomous vehicles which may be configured to be controlled using remote controls. Often, a particular remote control may be directly paired to a particular autonomous vehicle such that the particular remote control may substantially only be used to control that autonomous vehicle. Such a pairing generally remains, even when the remote control is not in use, until the remote control is unpaired from the vehicle, e.g., so that the remote control may be paired to a different vehicle.

When there are multiple remote controls and multiple vehicles, it may be difficult to identify the pairings between remote controls and vehicles. By way of example, if a user is in possession of a remote control device, it may not be readily apparent which vehicle is paired to the remote control device. If a user is mistaken about which vehicle is paired with a remote control device, there may be significant consequences if the user believes he or she is controlling one vehicle when, in fact, he or she is controlling a different vehicle.

In one embodiment, remote controls are arranged to be substantially unpaired to any vehicle except for when the remote controls are actively being used to control vehicles. When a vehicle is to be controlled, an unpaired or otherwise available remote control may be obtained, and temporarily paired to the vehicle so that the remote control may be used to control the vehicle. Once the vehicle no longer needs to be controlled, e.g., when a vehicle has completed a desired task or action, or once a predetermined amount of time has been reached, the vehicle and the remote control are effectively unpaired. By pairing a remote control with a vehicle each time the vehicle is to be remotely controlled, the association between the remote control and the vehicle may be readily apparent. In addition, the need to track which remote control is associated with which vehicle may be substantially eliminated, as remote controls are paired to vehicles each time the remote controls are to be used.

Further, a pairing process may be managed by a pairing system such that pairing between a vehicle and a remote control may be accomplished substantially without the vehicle and the remote control communicating directly. In one embodiment, a pairing process may involve verifying that a user in possession of a remote control is authorized to control a vehicle the user is requesting to pair with the remote control. Once a user is substantially authenticated and identified as having the authorization to control a particular vehicle, the remote control in the possession of the user may be paired to the particular vehicle. As a result, unauthorized control of the particular vehicle may be avoided.

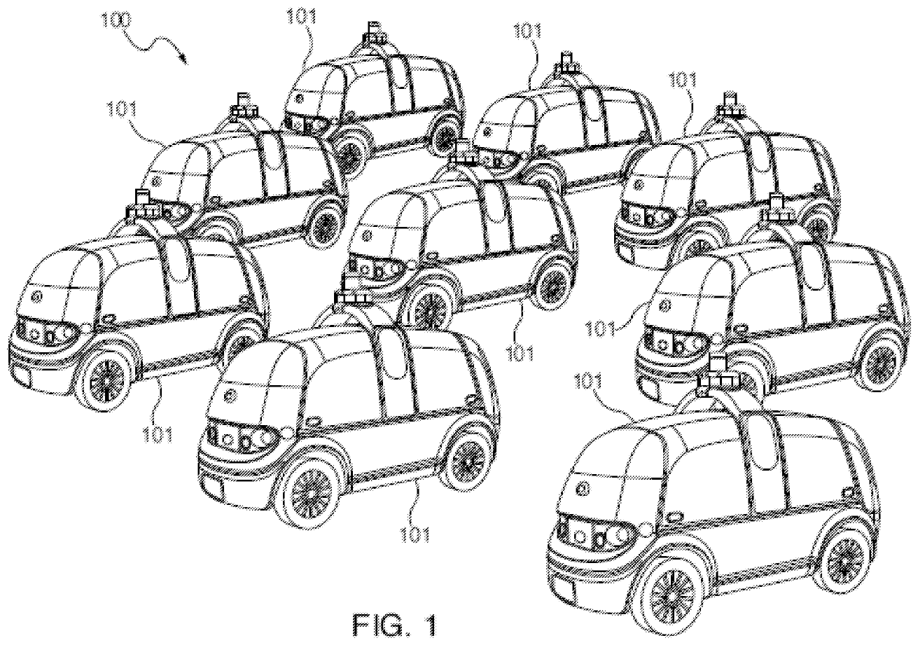

A vehicle that is arranged to be paired with a remote control may generally be part of a fleet of vehicles. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

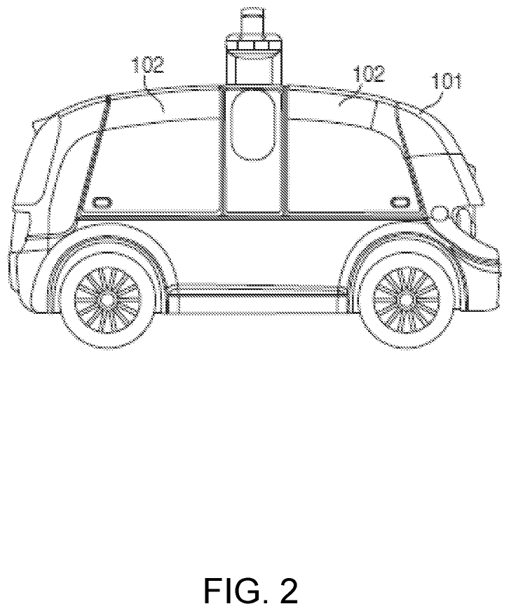

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

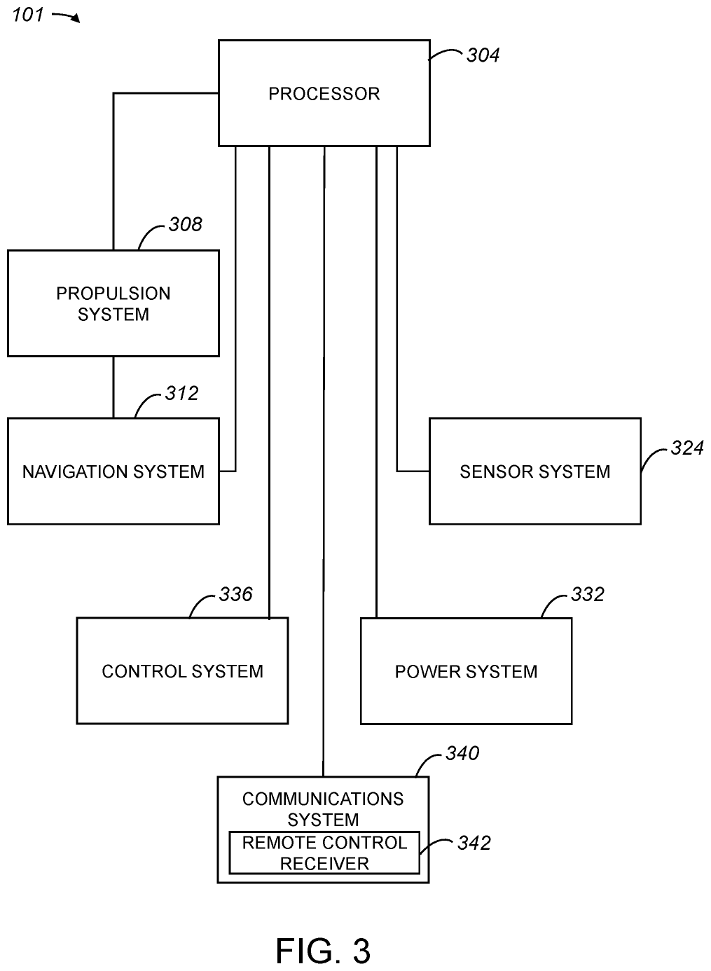

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand. In one embodiment, communications system 340 includes a remote control receiver 342 configured to allow for autonomous vehicle 101 to be controlled remotely through the use of a remote control. Remote control receiver 342 may be included on a brain stem computer (BSC) of autonomous vehicle 101.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode.

When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

In some situations, a remote control may be used by a user or an operator to control the operation of a vehicle, e.g., an autonomous or semi-autonomous vehicle. Typically, a remote control may be used to control the operation of a vehicle that is in relatively close physical proximity to a user who is in possession of the remote control. For example, a remote control may be used to control an autonomous vehicle from a chase vehicle that is following the autonomous vehicle. In addition, a remote control may be used to control an autonomous vehicle to move a relatively short distance, e.g., when the autonomous vehicle is at a staging location or the autonomous vehicle is to be moved unto a flatbed vehicle. A remote control may also be used to control an autonomous vehicle during a testing process.

Each vehicle in a fleet may be arranged to be paired to one remote control at any given time. In one embodiment, remote controls in a set of remote controls may each be arranged to be paired with a selected vehicle in a fleet at any given time. As such, the ability for a remote control to pair with a first selected vehicle at a first time, and then with a second selected vehicle at a second time after unpairing from the first selected vehicle allows a relatively small number of remote controls to effectively be used to operate a relatively large fleet of vehicles.

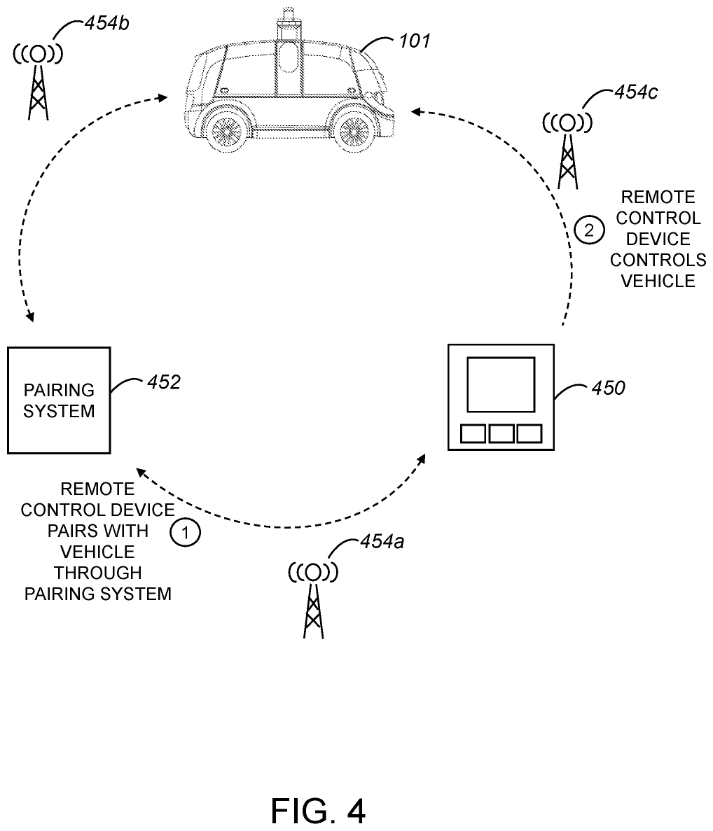

Referring next to FIG. 4, an overall system which allows a remote control to be paired with a vehicle through a pairing system, and allows the paired remote control to substantially directly control the vehicle, will be described in accordance with an embodiment. Vehicle 101 may be arranged to be controlled through the use of a remote control device 450. For example, once remote control device 450 is paired to vehicle, remote control device 450 may communicate with remote control receiver 342, as shown in FIG. 3, to provide instructions such as commands to or to otherwise control vehicle 101.

Remote control device 450 may include at least one user interface such as a screen, at least one antenna, software and/or hardware that allows remote control device 450 to communicate with pairing system 452 and vehicle 101, and to effectively issue instructions to vehicle 101. Typically, remote control device 450 is portable, e.g., handheld, although it should be appreciated that remote control device 450 is not limited to being a portable device.

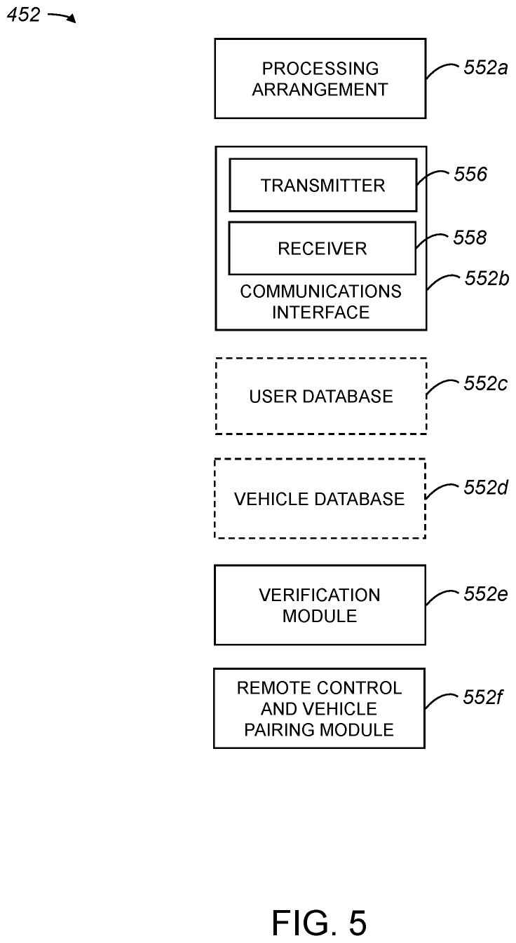

As mentioned above, a pairing system 452 may be used to pair remote control device 450 with vehicle 101. Pairing system 452, which will be described in more detail below with respect to FIG. 5, may be associated with a cloud server, or may generally be a system which communicates with remote control device 450 through a first network 454a and communicates with vehicle 101 through a second network 454b. Networks 454a, 454b may be any suitable wireless network including, but not limited to including, a Wi-Fi network, a Bluetooth network, an LTE network, and/or a 3G/4G/5G network. In one embodiment, networks 454a, 454b may be the same network.

Pairing system 452 effectively communicates with both remote control device 450 and vehicle 101 to cause remote control device 450 and vehicle 101 to pair together such that remote control device 450 may be used to command or to otherwise control vehicle 101. That is, pairing system 452 is essentially an intermediary between remote control device 450 and vehicle 101, and is configured to cause remote control device 450 to be paired with vehicle 101. For example, a user (not shown) may use remote control device 450 to communicate with pairing system 452 on network 454a, and pairing system 452 may then communicate with vehicle 101 in network 454a to effectuate a pairing between remote control device 450 and vehicle 101. Upon a successful pairing, remote control device 450 may then be used by a user (not shown) to substantially directly control vehicle 101 by communicating with vehicle 101 over a network 454c. Network 454c may be, but is not limited to being, a wireless network such as a Wi-Fi network, a Bluetooth network, an LTE network, and/or a 3G/4G/5G network. In one embodiment, networks 454a-c may be the same network.

FIG. 5 is a block diagram representation of pairing system 452 in accordance with an embodiment. In general, pairing system 452 includes hardware and/or software which is arranged to determine whether a user attempting to pair a remote control with a vehicle is authorized to control the vehicle and, in the event that the user is authorized to control the vehicle, to pair the remote control with the vehicle such that the remote control may be able to directly communicate with the vehicle. Pairing system 452 may be configured as a substantially single device or element, or pairing system 452 may be a distributed system. When pairing system 452 is a distributed system, pairing system 452 may include elements or components which communicate using one or more networks.

Pairing system 452 includes a processing arrangement 552a, a communications interface 552b, an optional user database 552c, an optional vehicle database 552d, a verification module 552e, and a remote control and vehicle pairing module 552f. Processing arrangement 552a includes one or more processors that may execute software code devices associated with pairing system 452.

Communications interface 552b may be arranged to support wired and/or wireless communications between pairing system 452 and remote controls (not shown), as well as between pairing system 452 and vehicles (not shown). Wireless communications supported by communications interface 552 may include, but are not limited to including, WiFi communications, LTE communications, and/or 3G/4G/5G communications. In one embodiment, communications interface includes a transmitter 556 arranged to transmit data or information from pairing system 452, and a receiver arranged to receive data or information on pairing system 452, e.g., from a remote control (not shown) and/or a vehicle (not shown).

In general, communications interface 552b may obtain information from a user and/or a remote control that is provided for purposes of authenticating the user and/or pairing the remote control to a selected vehicle. For example, communications interface 552b may obtain information which identifies a user, information which identifies a current location of the user, and/or information which indicates which vehicle or type of vehicle is proposed for pairing with a remote control.

Optional user database 552c is configured to store information relating to known and/or potential users of remote controls. It should be appreciated that if optional user database 552c is not included in pairing system 452, pairing system 452 may obtain user information from an external source such as an external database through the use of communications interface 552b. Information stored in optional user database 552c may include information which identifies a user, as well as information that indicates which vehicles associated with a fleet the user is authorized to operate, as for example through the use of a remote control. For example, information pertaining to a user may indicate which types of vehicles the user is substantially authorized to control and/or locations at which the user is substantially authorized to remotely command vehicles.

Optional vehicle database 552d is configured to store information associated with vehicles, as for example vehicles included in a fleet. It should be appreciated that if optional vehicle database 552d is not included in pairing system 452, pairing system 452 may obtain vehicle information from an external source such as an external database through the use of communications interface 552b. Information stored in optional vehicle database 552d may include, but is not limited to including, vehicle types, vehicle locations, vehicle capabilities, and/or an indication of which users may be authorized to operate particular vehicles.

Verification module 552e may analyze or otherwise process information contained in optional user database 552c and optional vehicle database 552d. Analyzing the information allows a user, e.g., an individual or an entity in possession of a remote control, generally includes, but is not limited to including, determining or otherwise assessing whether the user is authorized to remotely operate a selected vehicle, identifying at least one vehicle that the user is authorized to remotely operate, and/or determining whether a remote control in the possession of the user is suitable for pairing to a selected vehicle. That is, verification module 552e effectively verifies whether a user in possession of a remote control has the permissions necessary to remotely operate a selected vehicle.

Remote control and vehicle pairing module 552f is configured to pair a remote control with a particular vehicle, typically upon completion of a verification process performed by verification module 552e. Remote control and vehicle pairing module 552f may effectively enable a remote control (not shown) and a vehicle (not shown) to substantially recognize each other such that the vehicle may accept commands provided by the remote control. In one embodiment, remote control and vehicle pairing module 552f may effectively set a time limit for a pairing such that when the time limit is reached, no additional pairings involving a remote control (not shown) and/or a vehicle (not shown) may be allowed. It should be appreciated that in lieu of, or in addition to, not responding to additional pairing requests once a time limit is reached, a paired remote control (not shown) and vehicle (not shown) may substantially automatically unpair. In another embodiment, remote control and vehicle pairing module 552f may effectively set a pairing such that once either or both a remote control (not shown) and a vehicle (not shown) are powered down, no additional pairings may be allowed.

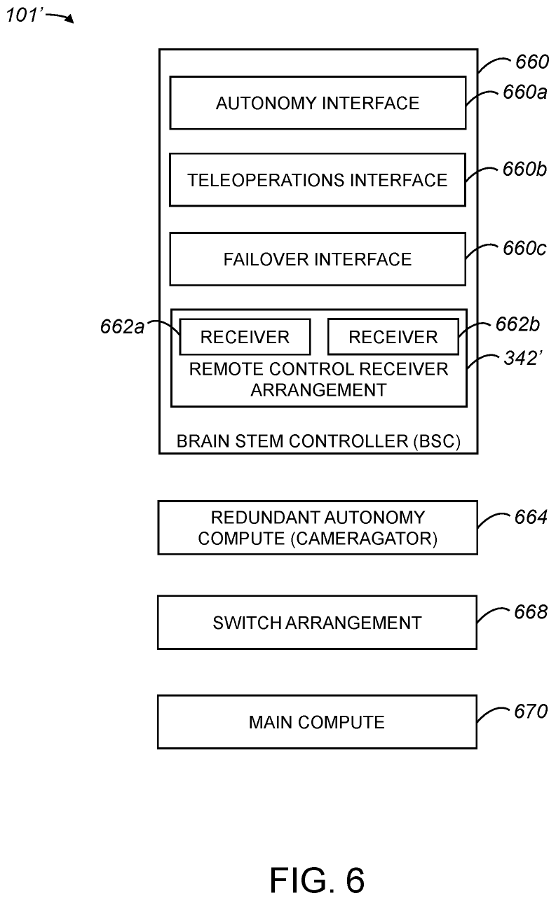

A remote control receiver arrangement such as remote control receiver arrangement 342 of FIG. 3 may generally support the pairing of a remote control such as remote control device 450 of FIG. 4 with vehicle 101. In one embodiment, a remote control device may be included in a BSC of a vehicle. FIG. 6 is a block diagram representation of an autonomous vehicle which includes a BSC that includes a remote control receiver arrangement, e.g., remote control receiver 342 of FIG. 3, in accordance with an embodiment. Autonomous vehicle 101′ may generally include components described above with respect to FIG. 3, as well as a BSC 660, a redundant autonomy compute 664, a switch arrangement 668 that includes at least one switch, and a main compute 670.

When a remote control (not shown) communicates with vehicle 101′, as for example over a wireless network, signals may be provided to redundant autonomy compute 664, which is in communication with switch arrangement 668 which is substantially communicably coupled to BSC 660. Redundant autonomy compute 664 may be arranged to support wireless communications such as WiFi, LTE, and/or 3G/4G/5G communications. Redundant autonomy compute 664 may include, but is not limited to including, functionality which supports teleoperations, a parallel autonomy system, and a failover autonomy system. In general, redundant autonomy compute 664 may provide redundancy in support of main compute 670 which includes a primary autonomy system (not shown).

Redundant autonomy compute 664 may be coupled to BSC 660 through switch arrangement 668. Switch arrangement 668 may include at least one Ethernet switch. BSC 660 may support vehicle controls including controls associated with control system 336 of FIG. 3, as well as remote control receiver arrangement 342′ which is arranged to enable a remote control (not shown) to communicate with vehicle 101′ to command or to otherwise control the operation of vehicle 101′.

In one embodiment, remote control receiver arrangement 342′ may include a plurality of receivers 662a, 662b. One receiver 662a may be a primary receiver, and the other receiver 662b may be a backup, or redundant, receiver arranged to be used to support remote operations in the event that receiver 662a does not operate as expected. Receivers 662a, 662b may include antennas (not shown), or may be communicably coupled to antennas (not shown).

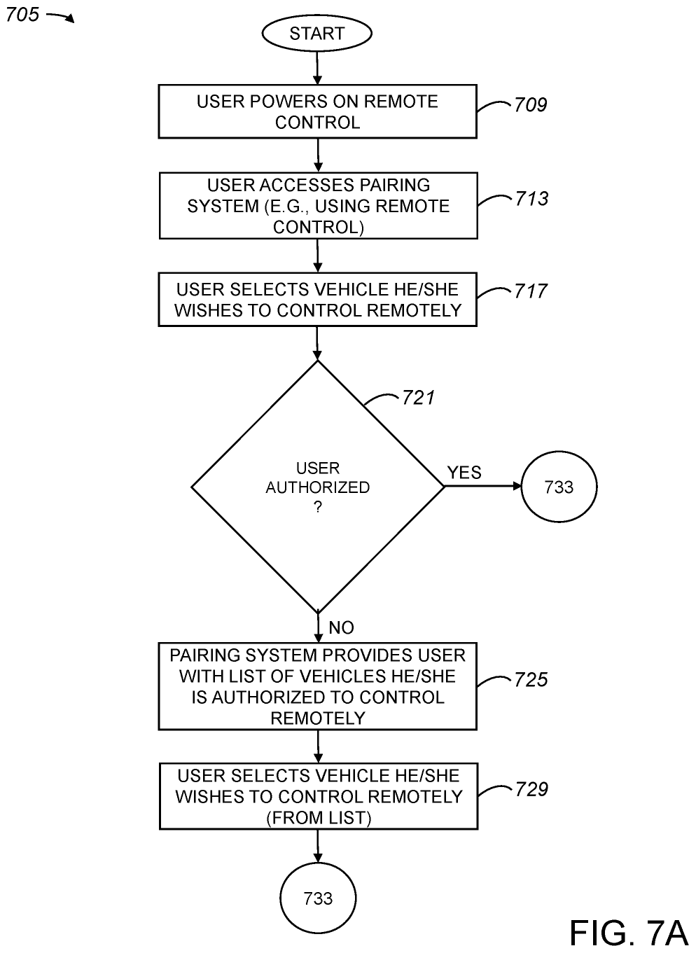

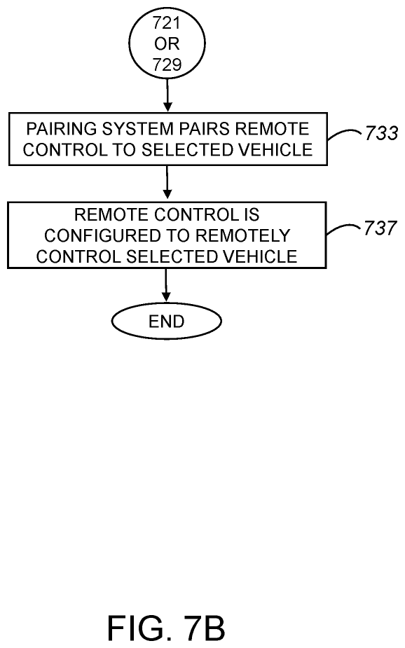

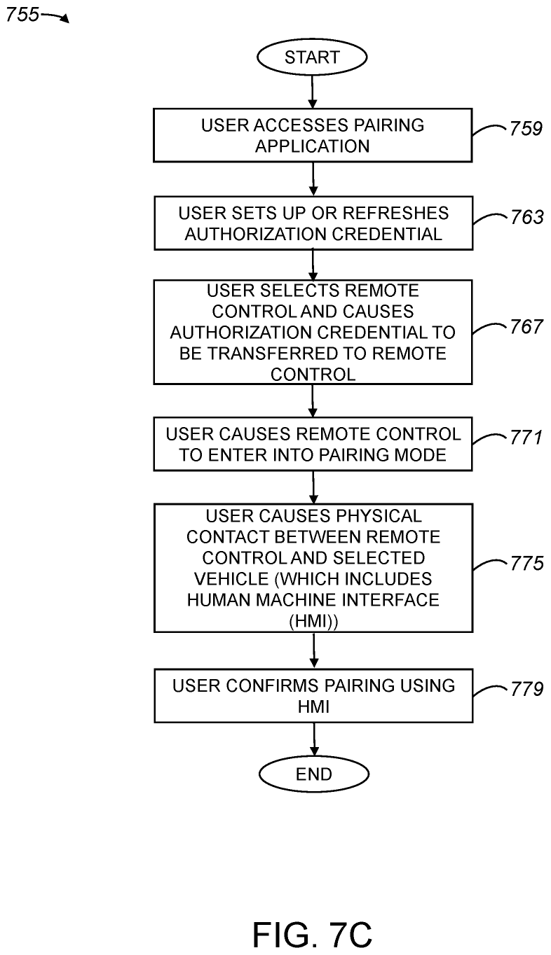

FIGS. 7A and 7B are a process flow diagram which illustrates a first method of pairing a remote control with a selected vehicle in accordance with an embodiment. A method 705 of pairing a remote control with a selected vehicle begins at a step 709 in which a user powers on a remote control. It should be appreciated that the remote control that is obtained by the user and subsequently powered on is generally free to be paired, i.e., is generally not already paired to a vehicle.

In a step 713, the user accesses a pairing system such as pairing system 452 of FIG. 4. The user may access a pairing system using any suitable device. By way of example, the user may use a computing system or a smart phone to access the pairing system. In one embodiment, the user may use the remote control to access the pairing system.

Once the user accesses the pairing system, the user may select at least one vehicle that the user wishes to control remotely in a step 717. Selecting one, multiple, and/or substantially all available vehicles may include, but is not limited to including, utilizing a user interface associated with the pairing system to identify the vehicle, using the remote control or other device in the possession of the user to scan a code on the vehicle to identify the vehicle. In one embodiment, the user may use a smart phone to scan codes such as QRs code associated with the remote control and the vehicle to essentially select the vehicle that the user wishes to control remotely using the remote control.

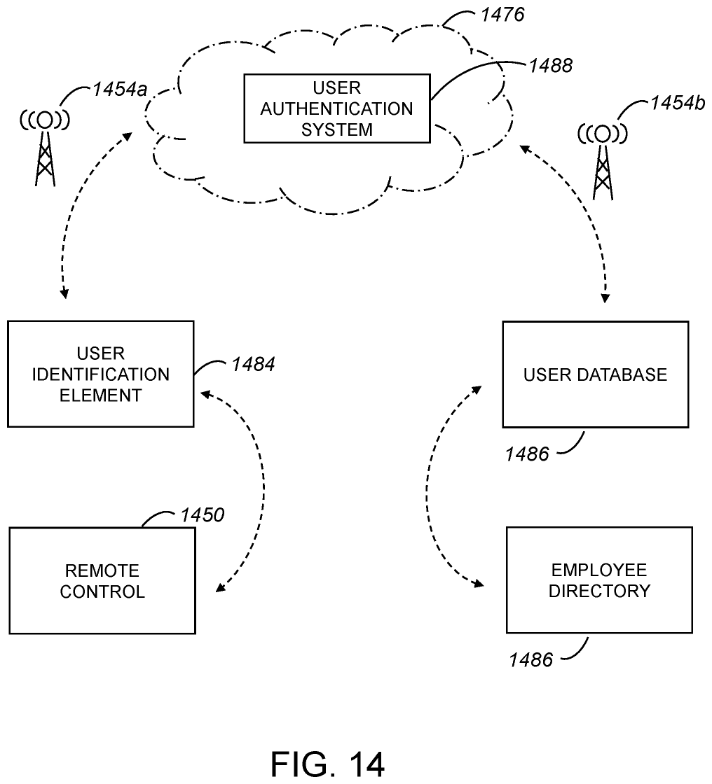

After the vehicle is selected in step 717, it is determined in a step 721 whether the user is authorized to remotely control the selected vehicle. A determination of whether the user is authorized to remotely control the selected vehicle generally involves, but is not limited to involving, ascertain whether the user has permissions and/or abilities necessary to remotely control the selected vehicle. Users may be authorized to remotely operate some types of vehicles but not other types of vehicles, or users may be authorized to remotely operate vehicles at some locations but not at other locations. By way of example, a user may be authorized to operate smaller vehicles but not authorized to operate larger vehicles, or a user may be authorized to operate a vehicle in a substantially closed space such as a parking lot but not authorized to operate a vehicle in a substantially open space such as a public road. Determining whether a user is authorized to remotely control a selected vehicle may also include determining whether the user has credentials which are current and, hence, not expired. Such credentials may be associated with the user and/or a remote control in the possession of, e.g., checked out by, the user. One system which enables a determination to be made as to whether a user is authorized to remotely control a selected vehicle will be discussed below with respect to FIG. 14.

If the determination in step 721 is that the user is not authorized to remotely control the selected vehicle, the implication is that the remote control is not to be paired to the selected vehicle. Accordingly, process flow proceeds to a step 725 in which the pairing system provides the user with a list of vehicles the user is authorized to control remotely. The list of vehicles may include types of vehicles the user is authorized to operate and/or vehicles at a location at which the user is authorized to operate vehicles. Alternatively, the list of vehicles may include specific vehicles the user is authorized to operate, e.g., a vehicle that is owned by the user or specifically configured for use by the user. The list of vehicles may be provided to the user through the remote control or through a different device associated with the user, e.g., a smartphone of the user.

Once the user is provided with a list of vehicles, the user selects a vehicle in a step 729 from the list that the user wishes to control remotely. Such a selection may generally be made using either the remote control or a different device associated with the user.

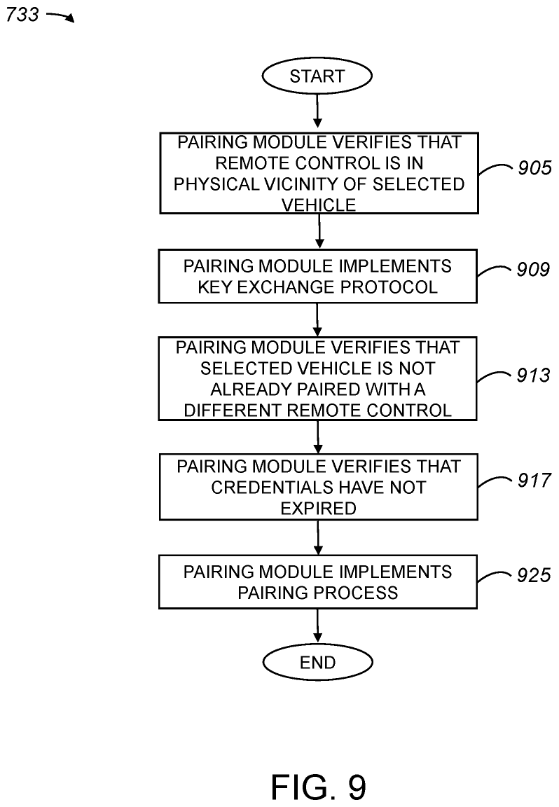

From step 729, process flow proceeds to a step 733 in which the pairing system pairs the remote control to the selected vehicle. The pairing system may communicate with the remote control and substantially separately with the selected vehicle to facilitate a pairing process. The pairing system may send pairing information to the remote control and send pairing information to the selected vehicle. Such pairing information may effectively complete a pairing process substantially without the remote control and the selected vehicle communicating directly. In other words, the pairing system is an agent that pairs the remote control and the selected vehicle. One method of enabling a pairing system to pair a remote control to a selected vehicle will be discussed below with reference to FIG. 9. After the remote control and the selected vehicle are paired, the remote control is configured to remotely control the selected vehicle in a step 737, and the method of pairing a remote control with a selected vehicle is completed.

Returning to step 721, if the determination is that a user is authorized to remotely control the selected vehicle, the indication is that the remote control may be paired with the selected vehicle. Accordingly, process flow moves from step 721 to step 733 in which the pairing system pairs the remote control to the selected vehicle.

In one embodiment, the pairing of a remote control in the possession of a user with a vehicle may involve the installation of an authentication credential on the remote control. With reference to FIG. 7C, a second method of pairing a remote control with a selected vehicle in accordance with an embodiment. A method 755 of pairing a remote control with a selected user begins at a step 759 in which a user accesses a pairing application, or an application that supports the authorization of the user with respect to a remote control as well as with respect to vehicles that he or she may be allowed to control. It should be appreciated that accessing the pairing application may generally include the user logging into the pairing application with his or her login credentials.

Once the user accesses the pairing application, the user sets up or refreshes an authorization credential in a step 763, or a credential which may indicate that the user is authorized to control one or more particular vehicles. An authorization credential may be set up if the user did not previously have an authorization credential, and an authorization credential may be refreshed if the user previously had an authorization credential. Setting up or refreshing the authentication credential may involve, but is not limited to involving, enabling the user to select the one or more vehicles he or she may be able to control using a remote control. When the user sets up or refreshes an authorization credential, the new or refreshed authorization credential may be provided to the user and/or may be stored substantially remotely.

In a step 767, the user selects a remote control for use, and causes the authorization credential to be transferred to, or otherwise loaded onto, the remote control. Then, in a step 771, the user causes the remote control to enter into a pairing mode. That is, the user may cause the remote control to be ready to pair with a selected vehicle.

After the user causes the remote control to enter into the pairing mode, the users causes physical contact between the remote control a selected vehicle in a step 775. That is, the user selects a vehicle that he or she wishes to control, and effectively causes the remote control to be paired to the vehicle. In one embodiment, causes physical contact may include, but is not limited to including, the user substantially tapping the remote control on the selected vehicle. Once the user causes physical contact between the remote control and the selected device, the user may confirm a pairing between the remote control and the selected vehicle using a human machine interface (HMI) on the selected vehicle in a step 776. For example, the HMI may display a confirmation screen which solicits input from the user that corresponds to a verification that the user intended to pair the remote control with the selected vehicle. Upon confirming a pairing, the method of pairing a remote control with a selected user is completed.

When a remote control is paired with a selected vehicle, the remote control may be used to remotely control the operation of the selected vehicle. In one embodiment, once the selected vehicle has completed a set of desired tasks or operations, the remote control and the selected vehicle are substantially automatically unpaired. Such an unpairing may occur when the remote control and the vehicle are no longer communicating, e.g., when the remote control and/or the vehicle are powered down. Alternatively, such an unpairing may occur when a connection between the remote control and the selected vehicle is substantially explicitly terminated, e.g., by a user of the remote control.

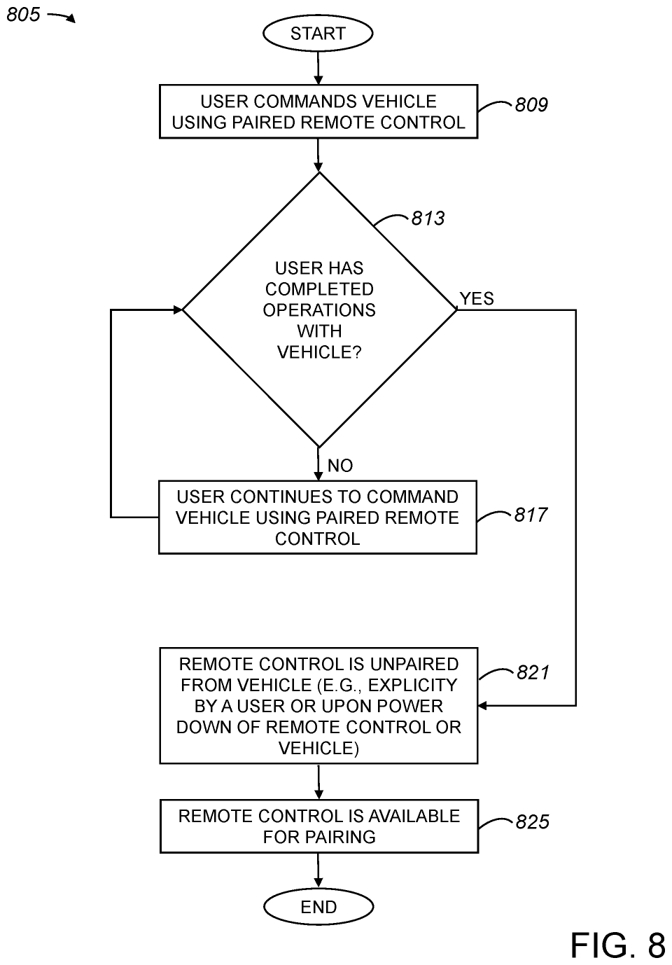

FIG. 8 is a process flow diagram which illustrates a method of utilizing a remote control that is paired to a vehicle in accordance with an embodiment. A method 805 of utilizing a remote control begins at a step 809 in which a user commands a vehicle using a remote control paired to the vehicle. In general, the remote control may send commands, e.g., instructions, to the vehicle over a wireless network. The vehicle may receive the commands on a remote control receiver, e.g., remote control receiver 342 of FIG. 3. The vehicle may respond to the commands by performing operations or otherwise executing actions.

In a step 813, it is determined whether the user has completed operations the user wishes to perform with the vehicle. That is, a determination is made as to whether the user will use the remote control to provide additional commands to the vehicle. If the determination is that the user has not completed operations with the vehicle, then in a step 817, the user continues to command the vehicle using the remote control. From step 817, process flow returns to step 813 in which it is determined whether the user has completed operations with the vehicle.

Alternatively, if it is determined in step 813 that the user has completed operations with the vehicle, then the remote control is unpaired from the vehicle in a step 821. The remote control and the vehicle may be unpaired, for example, upon the remote control and/or the vehicle effectively powering down. A user may also affirmatively unpair the remote control and the vehicle. After the remote control is unpaired, the remote control is essentially available for pairing to another vehicle in a step 825, and the method of utilizing a remote control is completed.

Referring next to FIG. 9, a method of pairing a remote control to a selected vehicle, e.g., step 733 of FIG. 7B, will be described in accordance with an embodiment. A method 733 of pairing a remote control to a selected vehicle begins at a step 921 in which a pairing module of the selected vehicle essentially verifies that the remote control is in the physical vicinity of the selected vehicle. That is, it is effectively verified that the remote control is within a particular distance away from the selected vehicle and/or is within a line-of-sight of the selected vehicle. Such a verification may be accomplished by determining that the remote control and the selected vehicle may communicate, e.g., using wireless communications. The distance between the remote control and the selected vehicle may vary widely. By way of example, the distance may be defined to be a distance which allows the remote control and the selected vehicle near field communications (NFC). A suitable distance may be less than approximately five feet, or less than a length of the selected vehicle, although it should be understood that the distance may vary widely. In one embodiment, verifying that the remote control is in the physical vicinity of the selected vehicle may include a user facilitating physical contact between the remote control and the selected vehicle, e.g., by tapping the remote control on the selected vehicle.

In a step 909, a pairing system, as for example pairing system 452 of FIG. 4, implements a key exchange protocol. The key exchange protocol is typically implemented between the remote control and the pairing module on the selected vehicle. Keys may effectively be exchanged between the remote control and the selected vehicle via the pairing system. A key exchange may occur between a remote control and a vehicle substantially directly, and may utilize a vehicle certificate on the vehicle side to authenticate the identity of the vehicle. On the remote control side, authorization credentials, as for example digital certificates, of a user as well as a remote control certificate may be used to substantially prove that a particular remote control is legitimate and to effectively confirm whether a user is authorized to use the remote control to control a selected vehicle.

In a step 913, the pairing module verifies that the selected vehicle is not already paired with a different remote control. That is, the pairing module verifies that the selected vehicle is available to be paired with the remote control. After the pairing module verifies that the selected vehicle is available to be paired with the remote control, the pairing module verifies that credentials have not expired, or are current, in a step 917. For example, some credentials may be valid for a fixed amount of time and/or have an expiration date and time. The pairing module may verify that credentials associated with the remote control are valid. The credentials may include certificates such as those obtained from a certificate authority for use during an authentical process.

Once the credentials are verified as not being expired, the pairing module implements a pairing process between the remote control and the selected vehicle in a step 925. In other words, the pairing module enables communications, e.g., NFC, between the remote control and the selected vehicle. Implementing the pairing process may include exchanging credentials such as certificates during a handshake that involves the remote control and the selected vehicle. The method of pairing a remote control and a selected vehicle is completed once the pairing module implements the pairing process.

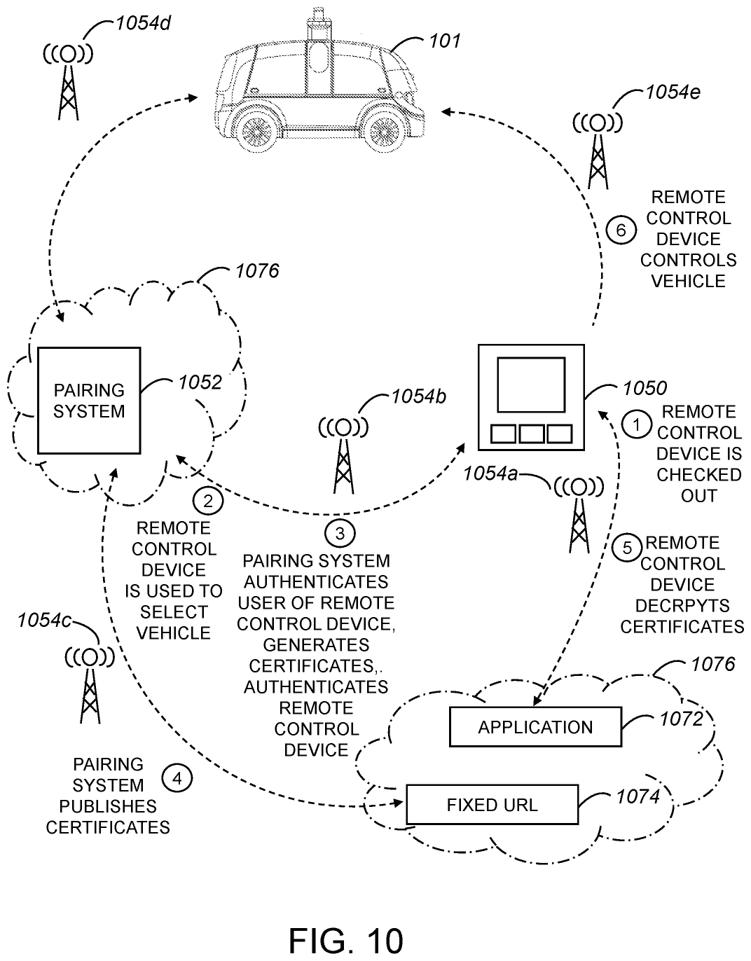

As mentioned above, certificates may be used to facilitate pairing between a remote control and a selected vehicle. The certificates, which may be part of a certificate set, are generally digital certificates used in an authentication process. As will be appreciated by those skilled in the art, certificates may be used to authenticate a remote control during a handshake that involves exchanging certificates. FIG. 10 is a diagrammatic representation of an overall system which allows a remote control to be paired with a vehicle through a pairing system that utilizes certificates, and allows the paired remote control to control the vehicle substantially directly in accordance with an embodiment. At a time t1, remote control device 1050 may be “checked out” or otherwise obtained by a user or an operator.

Checking out remote control device 1050 may generally involve associating a user to remote control device 1050. In one embodiment, the user may access an application 1072 using remote control device 1050, and effectively sign into an account that enables the user to specify that he or she has checked out remote control device 1050. Application 1072 may enable the user to enter an identifier associated with remote control device 1050, and essentially indicate that the user is in possession of remote control device 1050. Application 1072 may be stored and/or hosted on a server such as a cloud server 1076, and remote control device 1050 may communicate with application 1072 on a wireless network or Internet network 1054a.

At a time t2, remote control device 1050 is used to select vehicle 101 using a pairing system 1052. It should be appreciated that pairing system 1052 may be hosted by cloud 1076, and remote control device 1050 may communicate with pairing system 1052 on a wireless network 1054b. Vehicle 101 may effectively be identified to a user on remote control device 1050 such that the user may select vehicle 101 using an interface on remote control device 1050. Once the user signs into the account at time t1, the user may be provided with a list of vehicles that the user is substantially authorized to control. That is, remote control device 1050 may be used to select vehicle 101 from a set of vehicles. In one embodiment, the user may be presented with a list of substantially all vehicles that he or she has access to, e.g., permission to pair with remote control device 1050.

At a time t3, pairing system 1052 authenticates the user of remote control device 1050. It should be appreciated that pairing system 1052 may include a user authentication system that is arranged to authenticate users either as a part of a pairing process or before a pairing process, e.g., when users are authenticated with respect to an ability to remotely operate particular vehicles before a specific request is made to remotely operate vehicle 101. In addition, pairing system 1052 may also generate certificates, and authenticate remote control device 1050. Authenticating the user may include, but is not limited to including, identifying vehicles including vehicle 101 that the user has access to or is otherwise allowed to access. Pairing system 1052 may communicate with vehicle 101 on wireless network 1054d to identify vehicle 101 as being accessible to remote control device 1050. Pairing system 1052 may generate or otherwise obtain time-limited authorization certificates into a certificate set, or certificates which have a set expiration time, for use by remote control device 1050 and vehicle 101. The certificate set may be an opaque object that may subsequently be provisioned onto remote control device 1050 to essentially authorize remote control device 1050 to pair with certain vehicles, as for example vehicle 101. Pairing system 1052 may cause the certificate set to be encrypted with a trusted platform module (TPM) binding public key associated with remote control device 1050.

At a time t4, pairing system 1052 publishes an encrypted certificate set at a known location, e.g., a fixed universal record locator (URL) 1074 that may be associated with a cloud server 1076. Pairing system 1052 may communicate with fixed URL 1074 through a wireless network 1054c.

Once the encrypted certificate set is published, at a time t5, remote control device 1050 may poll fixed or static URL 1074 to identify the published encrypted certificate set. Upon obtaining the published encrypted certificate set, remote control device 1050 may decrypt the encrypted certificates in the certificate set. Then, at a time t6, remote control device 1050 may effectively control vehicle 101 by communicating with vehicle 101 over a wireless network 1054e. It should be appreciated that remote control device 1050 may communicate with vehicle 101 using Bluetooth communications, e.g., wireless network 1054e may be a Bluetooth network.

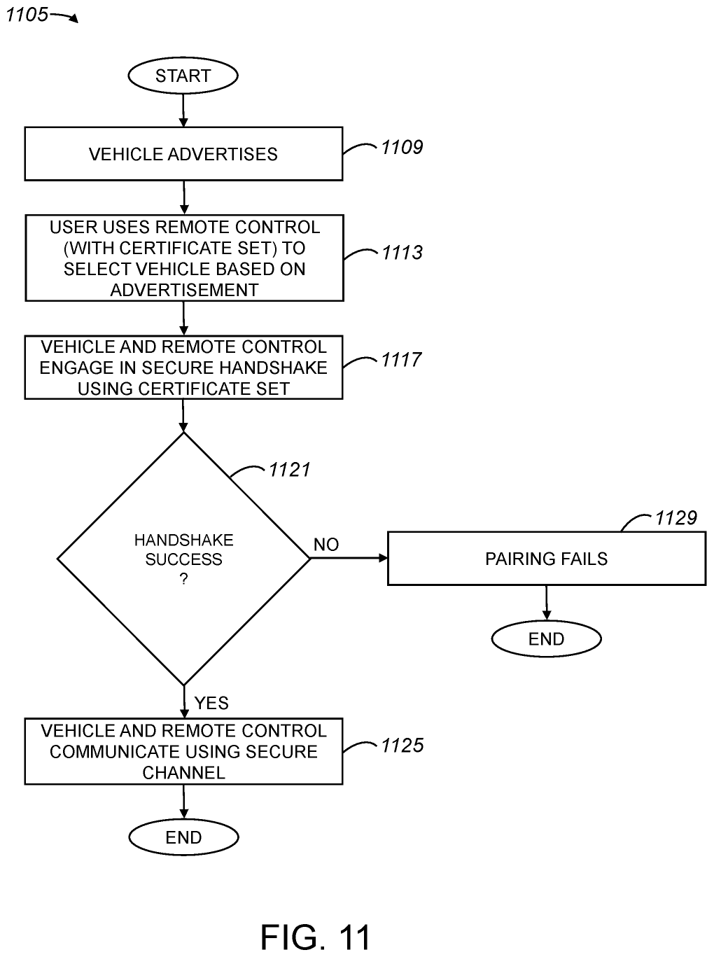

FIG. 11 is a process flow diagram which illustrates a method of pairing a remote control with a selected vehicle which involves the use of certificate sets in accordance with an embodiment. A method 1105 of pairing a remote control with a selected vehicle begins at a step 1109 in which a vehicle that is available to be paired to a remote control advertises an identity. The vehicle may effectively broadcast an advertisement that may be received or otherwise obtained by a node or device that may be on the same network as the vehicle.

A user or operator with a remote control which has a certificate set may select the vehicle for pairing based on the advertisement sent or otherwise provided by the vehicle in a step 1113. The user may use the remote control to select the vehicle. In one embodiment, a user may select the vehicle by tapping the remote control on the vehicle, e.g., by using NFC, in order to begin a pairing process. Then, in a step 1117, the vehicle and the remote control may engage in a secure handshake process using the certificate set. In one embodiment, the certificate set of the remote control and one or more certificates associated with the vehicle may be used during the secure handshake process.

A determination is made in a step 1121 as to whether the handshake was successful. That is, it is determined whether the remote control may pair with the vehicle such that the remote control, which is effectively checked out by or in the possession of the user, may be used to control the vehicle. In one embodiment, determining whether the handshake was successful may include a user confirming an initiation of pairing by interacting with an HMI on the vehicle. If the determination is that the handshake is not successful, the pairing between the vehicle and the remote control fails in a step 1129, and the method of pairing a remote control with a selected vehicle is terminated.

Alternatively, if it is determined in step 1121 that the handshake is successful, the indication is that the vehicle and the remote control may be paired. Accordingly, in a step 1125, the vehicle and the remote control are allowed to communicate using a secure channel, and the method of pairing a remote control with a selected vehicle is completed.

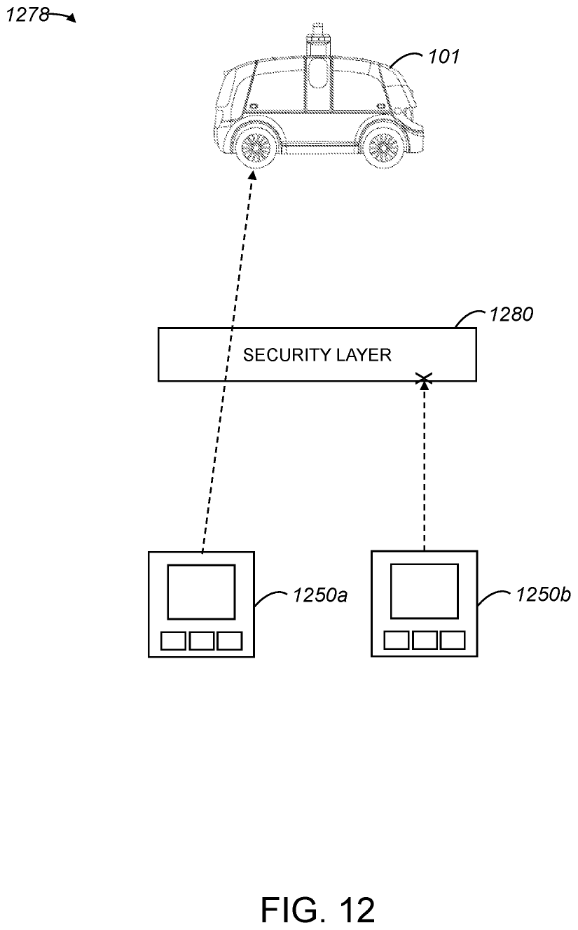

In general, a remote control which may be paired with a vehicle such as an autonomous or semi-autonomous vehicle may be granted the ability to be paired or denied the ability to be paired. Effectively, a security layer may serve as a gate keeper which determine whether a particular remote control may be paired with a vehicle at a particular time. That is, a security layer may essentially determine whether a particular remote control is authorized for use to control a particular vehicle. FIG. 12 is a diagrammatic representation of an overall system which allows a remote control to be paired with a vehicle in accordance with an embodiment. An overall system 1278 which allows remote controls to be substantially authorized to pair with vehicles includes at least one vehicle 101, at least one remote control 1250a, 1250b, and an effective security layer 1280. For purposes of discussion two remote controls 1250a, 1250b are illustrated, although it should be understood that the number of remote controls 1250a, 1250b may vary widely.

Vehicle 101 may be an autonomous vehicle which includes functionality to enable vehicle 101 to interface with remote controls 1250a, 1250b if remote controls 1250a, 1250b are authorized. Remote controls 1250a, 1250b are generally each configured to be paired with any one of multiple vehicles.

Security layer 1280 includes functionality, as for example functionality associated with a pairing system, which enables one of remote controls 1250a, 1250b to be paired with vehicle 101 to control vehicle 101. Security layer 1280 may also be configured to effectively ensure the integrity of communication between a selected remote control 1250a, 1250b by facilitating a secure communications channel between the selected remote control 1250a, 1250b and vehicle 101.

In the embodiment as shown, security layer 1280 may determine that remote control 1250a is authorized to pair with vehicle 101, and may allow a secure communications channel to be established between remote control 1250a and vehicle 101. When remote control 1250a is paired with vehicle 101, remote control 1250a and vehicle 101 may share a symmetric key.

Remote control 1250b is not authorized to pair with vehicle 101. Remote control 1250b may not be authorized because vehicle 101 is already paired with remote control 1250a, and/or because remote control 1250b does not have appropriate permissions, e.g., certificates, to pair with vehicle 101.

When a remote control is no longer needed to control a vehicle, e.g., when a user of a remote control no longer has a need to control a vehicle with which the remote control is paired, the remote control may be unpaired from the vehicle. The unpairing of a remote control from a vehicle may be substantially automatic when the remote control is powered off. For example, when a remote control is powered off, as part of the powering down process, the remote control may be substantially automatically unpaired from the vehicle. Alternatively, a remote control may be substantially unpaired from a vehicle after a predetermined amount of time has elapsed. In one embodiment, a pairing system such as pairing system 452 of FIG. 4 or pairing system 1052 of FIG. 10 may determine that a remote control is powered off or that a predetermined amount of time has elapsed, and may cause the remote control to unpair from a vehicle. Deleting a certificate set or an opaque object from the remote control may generally cause the remote control to unpair from the vehicle.

In one embodiment, potential users of remote controls, e.g., operators, may be authenticated such that a potential user may be identified as being authenticated and/or authorized to control vehicles using a remote control otherwise. In such an embodiment, remote controls may be separately authenticated or authorized effectively to identify the remote controls as suitable for use to control vehicles. As a result, an authorized user may use an authorized remote control to control a vehicle.

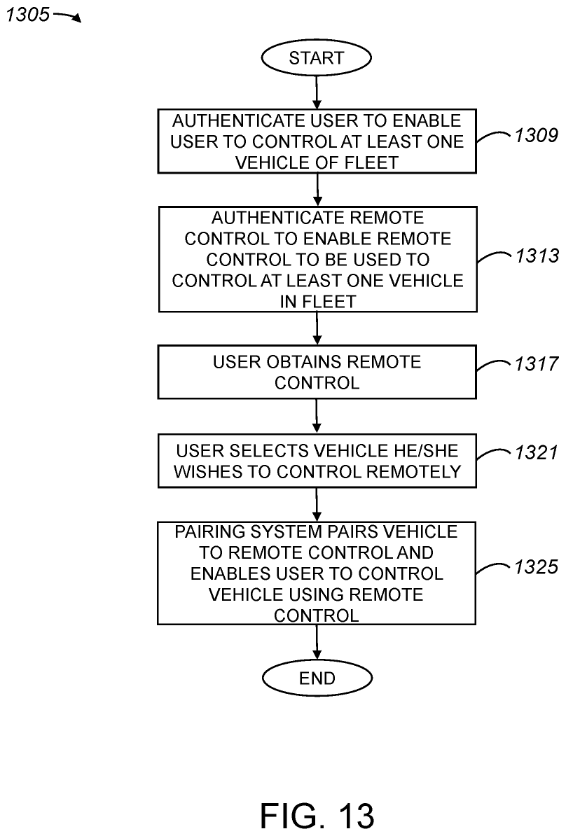

FIG. 13 is a process flow diagram which illustrates a method of enabling an authenticated user to use an authenticated remote control to control a vehicle in accordance with an embodiment. A method 1305 of enabling an authenticated user to use an authenticated remote control to control a vehicle begins at a step 1309 in which a user is authenticated such that the user is effectively identified as having permission to control at least one vehicle, e.g., at least one vehicle included in a fleet of vehicles. Authenticating the user may include, but is not limited to including, a user authentication system or a pairing system verifying credentials associated with the user.

In a step 1313, a remote control is authenticated to enable the remote control to be used to control at least one vehicle included in the vehicle fleet. Authenticating or authorizing the remote control may include, but is not limited to including, an authentication system or pairing system verifying that the particular remote control may be used to control at least one vehicle included in the vehicle fleet.

The user may obtain the remote control in a step 1317, and may use the remote control or, more specifically, user interfaces associated with the remote control, to select a vehicle to control. After the vehicle is selected, a pairing system pairs the vehicle to the remote control in a step 1325. Pairing the selected vehicle to the remote control enables the user to use the remote control to control the selected vehicle. The method of enabling an authenticated user to use an authenticated remote control to control a vehicle is completed upon the user being provided with the ability to use the remote control to control a selected vehicle.

As mentioned above with respect to FIGS. 7A and 7B, a system may be configured to ascertain whether a user is authorized to remotely control a vehicle. Attributes which define one or more types of vehicles that a user or operator is allowed to control may be embedded in a digital certificate, as for example a cryptographically signed certificate. A corresponding cryptographic private key may be used during the pairing process as part of a cryptographic handshake. After the handshake, the vehicle may then substantially know attributes associated with the user or operator, and may verify the attributes against configured attribute of the vehicle, e.g., a vehicle ID. FIG. 14 is a block diagram representation of a system which enables a determination to be made as to whether a user is authorized to remotely control a vehicle, in accordance with an embodiment. When a user is to be authenticated to determine whether he or she has authorization to use a remote control 1450 to control a selected vehicle, a user authentication system 1488, which may be located in a network cloud 1476, may be accessed to compare a user identification element 1484 against a user database 1486. User identification element 1484, which provides information such as attributes associated with a user, may be an RFID tag or badge in the possession of the user. Information may be obtained from user identification element 1484, as for example through an interface provided on remote control 1450, and provided through a network 1454a to cloud 1476. Using information associated with user identification element 1484, user authentication system 1488 may access user database 1486 through a network 1454b.

User database 1486 may contain information which identifies the permissions held by users. The information may include one or more attributes associated with users. For example, user database 1486 may store data relating to types of vehicles that a particular user may remotely control, types of remote controls the particular user may use, locations at which the particular user may remotely control a vehicle, and/or levels of permissions which identify the functions the particular user may control. In one embodiment, user database 1486 may access an employee directory or database 1486 which identifies the employment status of users named in user database 1486. Information from employee direction 1486 may indicate whether a user is an ex-employee of an enterprise and, thus, may cause information associated with the user to be updated in user database 1486, e.g., to specify that any permissions the user may have had are currently rescinded.

An overall system which enables a user to be authenticated, enables the user to be paired to a remote control, and enables the remote control to be paired to an end device, e.g., a vehicle, may generally utilize network connections such as internet connections as described above with respect to FIG. 10. In one embodiment, a remote control may be paired to a vehicle substantially without requiring internet connectivity. The ability to enable a remote control to pair with a vehicle substantially without internet connectivity or availability facilitates the use of a remote control to control a vehicle as the pairing may occur in a location without access or reliable access to network services, and/or the pairing may occur when an internet connection is either temporarily or substantially permanently unavailable.

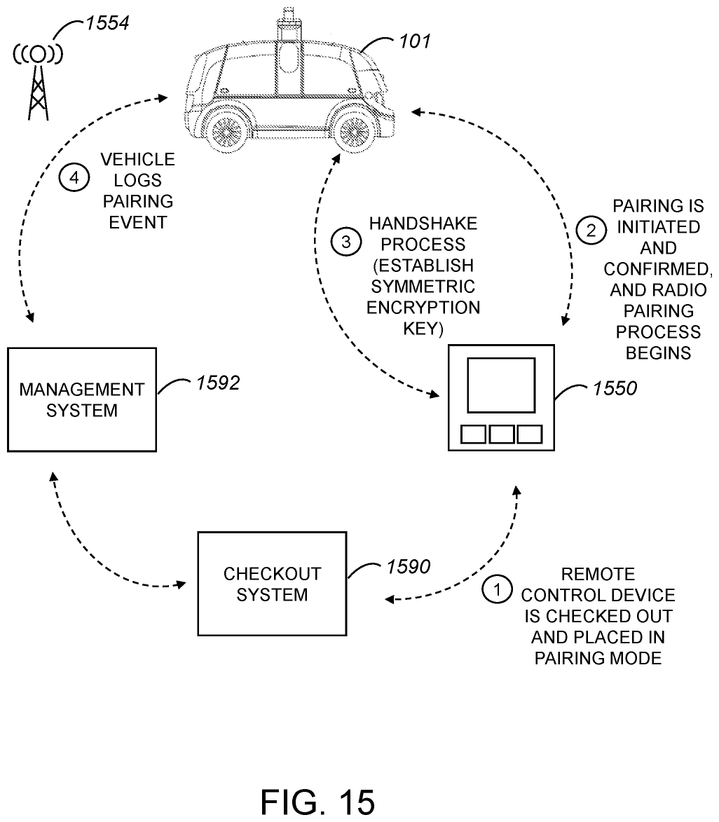

FIG. 15 is a diagrammatic representation of an overall system which allows a remote control to be paired with a vehicle through a pairing system without access to an internet connection, e.g., through the use of a radio communications channel, in accordance with an embodiment. A remote control device 1550 may be checked out by a user or an operator from a checkout system 1590 at a time t1, and placed in a pairing mode. It should be appreciated if remote control device 1550 is already paired with any vehicle, remote control device 1550 may not be placed in a pairing mode until the previous pairing is effectively terminated. As part of a process of checking out remote control device 1550, an authorization credential or certificate associated with the user may effectively be loaded onto or otherwise made available to remote control device 1550, e.g., by checkout system 1590. In one embodiment, checkout system 1590 is arranged to store authorization credentials associated with users who have undergone an authorization or authentication process.

The user may select a suitable authorization credential and cause the authorization credential to be substantially transferred from checkout system 1590 to remote control device 1550. Such a transfer may be recorded in a management system 1592, as for example if checkout system 1590 has network connectivity such as internet connectivity.

At a time t2, pairing is initiated and confirmed, and a radio pairing process, e.g., a pairing process using NFC communications, may begin between remote control device 1550 and vehicle 101. In one embodiment, initiating the pairing involves remote control device 1550 physically contacting vehicle 101. When vehicle 101 is not moving, vehicle 101 may send a vehicle identifier as well as connection information for a radio communication layer upon remote control device 1550 touching vehicle 101. Remote control device 1550 may begin communicating with vehicle 101 using radio communications, and an HMI on vehicle 101 may display information relating to a pairing which the user may confirm. Vehicle 101 may effectively initiate a radio pairing process upon obtaining confirmation, as for example through the HMI on vehicle 101.

At a time t3, a handshake process between vehicle 101 and remote control device 1550 commences. Remote control device 1550 provides an authorization credential, e.g., an authorization credential associated with the user who checked out remote control device 1550, and a remote control certificate. The remote control certificate may be a key, e.g., a key that is a compressed format of a public key such as an X.509 public key. Vehicle 101 provides a vehicle certificate. During the handshake, the vehicle certificate, the remote control certificate, and/or the authorization credential may be substantially processed to establish a symmetric encryption key. In addition to establishing a symmetric encryption key, remote control device 1550 has the vehicle identifier for vehicle 101, and vehicle 101 has a remote control identifier for remote control device 1550. Vehicle 101 also has the authorization credential and one or more associated digital certificates. Vehicle 101 may check to determine if the remote control identifier and/or the authorization credential are on any certificate revocation list.

When substantially all certificates are properly signed and determined to be current, the handshake process may be successfully completed. Upon completion of the handshake process, a symmetric encryption key is established. Then, at a time t4, vehicle 101 may communicate with management system 1552 to effectively log or otherwise track the pairing between vehicle 101 and remote control device 1550. Such communications may occur over a network 1554.

Although only a few embodiments have been described in this disclosure, it should be understood that the disclosure may be embodied in many other specific forms without departing from the spirit or the scope of the present disclosure. By way of example, by allowing a pairing between a vehicle and a remote control to be substantially terminated upon either or both the vehicle and the remote control powering down, or upon a predetermined amount of time lapsing, the risks associated with an unauthorized person remotely operating a vehicle is reduced. It should be appreciated, however, the pairing of a vehicle and a remote control using a pairing system such as pairing system 452 of FIG. 4, may not necessarily be temporary. That is, the use of a pairing system to pair a vehicle and a remote control is not limited to embodiments in which the pairing is effectively temporary.

Vehicles which may not be paired to particular remote controls by users have generally been described as being vehicles that the users are not authorized to control remotely. In one embodiment, a pairing system may be unable to pair a remote control in the possession of the user to a selected vehicle for other reasons. Such other reasons may include, but are not limited to including, the selected vehicle being unavailable due to a physical issue, the selected vehicle being unavailable due to routine maintenance, the selected vehicle being reserved for use by a different user, the selected vehicle already being paired to a different remote control, and/or the selected vehicle not having the capability to be operated using a remote control.

When a user utilizes a pairing system to pair a remote control with a vehicle, the user may access the pairing system using the remote control or a different device, such as a smartphone, as discussed above. A remote control or another device may have an application that is configured to communicate with the pairing system to facilitate the pairing. That is, a pairing system that pairs a remote control with a selected vehicle may use an application loaded on the remote control or on another device to identify the remote control and the selected vehicle, and to cause the remote control to be paired with the selected vehicle.

In one embodiment, when a remote control is used to remotely operate an autonomous vehicle, the type of operations the remote control may substantially initiate may be limited. That is, in some cases, the functions of an autonomous vehicle which may be controlled by a remote control may be different from, or may be a subset of, functions of the autonomous vehicle when the autonomous vehicle is under the control of an autonomy system or a teleoperator. By way of example, a remote control may be used to control a subset of functions of the autonomous vehicle for testing purposes. Alternatively, the remote control may be used substantially only for purposes of remotely operating the vehicle at a slow speed, e.g., to move the vehicle in a parking lot or to move the vehicle to a side of a road.

A remote control has been described as communicating with a vehicle using wireless communications such as Wi-Fi, LTE, Bluetooth, and/or 3G/4G/5G communications. It should be appreciated that other types of wireless communications and wireless networks may be used to enable a remote control to substantially control or command a vehicle. For instance, ultra-wideband (UWB) communications may be used to enable a remote control to communicate with a vehicle without departing from the spirit or the scope of the disclosure.

In one embodiment, substantially all pairings between remote controls and vehicles may be logged or otherwise tracked. Logging pairings, as for example in a data store associated with a cloud server, will generally enable the pairings to be audited. Remote pairings may be logged when a remote control and a vehicle have a network connection such as an internet connection.

A root key, e.g., a relatively long-term identity key, may be stored on a vehicle. In addition, an identity key that is more accessible than the root key may be stored on the vehicle for the purpose of enabling the vehicle to be identified during pairing substantially without the need to access the root key which may be stored on a main compute system or more secure system on the vehicle. For example, the identity key may be stored on BSC 660 of FIG. 6 while the root key may be stored on main compute 670 of FIG. 6.

A remote control has been described as being paired with a vehicle, e.g., an autonomous vehicle, such that the autonomous vehicle may be controlled by the remote control. It should be appreciated that the methods of pairing a remote control with a vehicle may generally be applied to apparatuses other than vehicles, e.g., the methods may be applied to pairing a remote control with any suitable robotic apparatus such as a humanoid robot or a sidewalk delivery robot. In general, methods of pairing a remote control may be applied to substantially any electronic device which may be controlled with a remote control. In other words, a remote control in accordance with the disclosure is not limited to being paired to a vehicle.

A user authentication system which may enable a user to be authenticated or authorized to control a vehicle using a remote control may be substantially connected to other systems associated with an enterprise. For example, a user authentication system may be in communication with an employment database to facilitate a determination of whether a user is employed by an enterprise and, therefore, potentially has permissions to remotely operate a vehicle associated with the enterprise. Such an employment database may also facilitate the ability of an enterprise to rescind or otherwise remove permissions a user may have to remotely operate a vehicle, e.g., the employment database may provide information that terminates permissions associated with a particular user when that user is no longer employed by the enterprise.

When a vehicle pairs with a remote control, the pairing may effectively be logged, as for example by a pairing system or by a remote control management system. In one embodiment, when a vehicle pairs with a remote control, the vehicle may determine whether any certificates are on a certificate revocation list. That is, it may be verified whether all certificates are properly signed and not expired. Pairing between a remote control and a vehicle may commence if substantially all certificates are properly signed and current. When a pairing is unsuccessful, information associated with an unsuccessful pairing may also be logged.

A user may specify an expiration time or date at which point an authorization credential or certificate may no longer be valid. Such an expiration time or data may be specified for one or more vehicles. Conditions associated with an expiration time or date, as well as the vehicles to which the expiration time or date relate to, may be substantially monitored and enforced by a management system. When a user attempts to pair a remote control with a vehicle, the checkout system may communicate with the management system to effectively authenticate the user, and to check permissions associated with the user. When a requested expiration date or time is before a maximum allowed expiration date or time, then a digital certificate, e.g., an authorization credential, may be signed and logged. As mentioned above, a checkout system may store the authorization credential.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. By way of example, FIGS. 7A and 7B describe a pairing system providing a user with a list of vehicles that the user is authorized to substantially operate. It should be understood that in some embodiments, a user may not be authorized to operate any vehicle. In such embodiments, the pairing system may indicate to the user that the user does not have permissions to operate any vehicle. Therefore, the present examples are to be considered as illustrative and not restrictive, and the examples are not to be limited to the details given herein, but may be modified within the scope of the appended claims.

What is claimed is:

1. A method comprising:
identifying a remote control as attempting to pair with a first vehicle;
determining whether the remote control is authorized to pair with the first vehicle, wherein determining whether the remote control is authorized to pair with the first vehicle includes determining whether credentials associated with the remote control indicate that the remote control is authorized to pair with the first vehicle; and
causing the remote control to pair with the first vehicle when it is determined that the remote control is authorized to pair with the first vehicle, wherein causing the remote control to pair with the first vehicle enables the remote control to remotely control the first vehicle.

2. The method of claim 1 wherein determining whether the credentials associated with the remote control indicate that the remote control is authorized to pair with the first vehicle includes determining whether the credentials are current, wherein when the credentials are current, it is determined that the remote control is authorized to pair with the first vehicle.

3. The method of claim 1 wherein the first vehicle is of a first type, determining whether the credentials associated with the remote control indicate that the remote control is authorized to pair with the first vehicle includes determining whether the credentials indicate that the remote control is suitable for use to control vehicles of the first type.

4. The method of claim 1 wherein the credentials identify a user authorized to operate the first vehicle, and wherein determining whether the remote control is authorized to pair with the first vehicle includes determining whether the remote control is within a predetermined distance from the first vehicle.

5. The method of claim 1 wherein causing the remote control to pair with the first vehicle includes exchanging keys between the remote control and the first vehicle and establishing a communications channel between the remote control and the first vehicle, the communications channel being a radio communications channel.

6. The method of claim 5 further including:
enabling the remote control to control the first vehicle using the communications channel.

7. The method of claim 1 wherein when the remote control is identified as attempting to pair with the first vehicle, the remote control is not already paired with the first vehicle.

8. Logic encoded in one or more tangible non-transitory, computer-readable media for execution and when executed operable to:
identify a remote control as attempting to pair with a first vehicle;
determine whether the remote control is authorized to pair with the first vehicle, wherein the logic operable to determine whether the remote control is authorized to pair with the first vehicle is operable to determine whether credentials associated with the remote control indicate that the remote control is authorized to pair with the first vehicle; and
cause the remote control to pair with the first vehicle when it is determined that the remote control is authorized to pair with the first vehicle, wherein the logic operable to cause the remote control to pair with the first vehicle enables the remote control to remotely control the first vehicle.

9. The logic of claim 8 wherein the logic operable to determine whether the credentials associated with the remote control indicate that the remote control is authorized to pair with the first vehicle includes logic operable to determine whether the credentials are current, wherein when the credentials are current, it is determined that the remote control is authorized to pair with the first vehicle.

10. The logic of claim 8 wherein the first vehicle is of a first type, and wherein the logic operable to determine whether the credentials associated with the remote control indicate that the remote control is authorized to pair with the first vehicle is operable to determine whether the credentials indicate that the remote control is suitable for use to control vehicles of the first type.

11. The logic of claim 8 wherein the credentials identify a user authorized to operate the first vehicle, and wherein the logic operable to determine whether the remote control is authorized to pair with the first vehicle includes logic operable to determine whether the remote control is within a predetermined distance from the first vehicle.

12. The logic of claim 8 wherein the logic operable to cause the remote control to pair with the first vehicle is operable to exchange keys between the remote control and the first vehicle and to establish a communications channel between the remote control and the first vehicle.

13. The logic of claim 12 wherein the logic is further operable to enable the remote control to control the first vehicle using the communications channel.

14. The logic of claim 8 wherein when the remote control is identified as attempting to pair with the first vehicle, the remote control is not already paired with the first vehicle.

15. A pairing system comprising:
a communications interface, the communications interface configured to enable communications on a network with a remote control and with a first device;
a processing arrangement; and
logic encoded in one or more tangible non-transitory, computer-readable media for execution by the processing arrangement and when executed operable to determine when the remote control is authorized to pair with the first device by determining whether credentials associated with the remote control indicate that the remote control is authorized to pair with the first device, and when it is determined that the remote control is authorized to pair with the first device, causing the remote control to pair with the first device such that the remote control controls operation of the first device.

16. The pairing system of claim 15 wherein the credentials are associated with a user and the first device is a first vehicle is of a first type, the paring system further including:
at least one database, the at least one database configured to store information relating to the user, the information including an indication of whether the user is authorized to control vehicles of the first type.

17. The pairing system of claim 15 wherein the logic operable to determine when the remote control is authorized to pair with the first device includes logic operable to determine whether the remote control is within a predetermined distance from the first device.

18. The pairing system of claim 15 wherein the logic operable to cause the remote control to pair with the first device is operable to cause an exchange of keys between the remote control and the first device and to establish a communications channel between the remote control and the first device, the communications channel being a radio communications channel.

19. The pairing system of claim 15 wherein the logic operable to determine when the remote control is authorized to pair with the first device by determining whether credentials associated with the remote control indicate that the remote control is authorized to pair with the first device includes logic operable to determine whether the credentials are current, wherein when the credentials are current, it is determined that the remote control is authorized to pair with the first device.

20. The pairing system of claim 15 wherein the communications interface is configured to obtain information which identifies a user of the remote control and information which identifies the first device.
